(19) United States
(12) Patent Application Publication
(10) Pub. No.: US 2026/0154678 A1
(43) Pub. Date: Jun. 4, 2026

(54) CONVERTING CARD-NOT-PRESENT TO CARD-PRESENT TRANSACTIONS FOR ONLINE TRANSACTIONS

(71) Applicant: MASTERCARD INTERNATIONAL INCORPORATED, Purchase, NY (US)

(72) Inventors: Ameya Dandekar, Pune (IN); Bhushan Raut, Nagpur (IN); Jitendra Singh Wadhwa, Pune (IN)

(21) Appl. No.: 18/967,092

(22) Filed: Dec. 3, 2024

(51) Int. Cl. G06Q 20/38; G06Q 20/32

(52) U.S. Cl. CPC G06Q 20/385; G06Q 20/3278

(57) ABSTRACT

Systems and techniques for converting card-not-present to card-present transactions for online transactions can include a method, including: capturing, via a NFC-enabled device, a QR code enabling a physical payment card payment for an online transaction at an online merchant; decoding the QR code; and executing the soft-POS instance by: directing a browser to open on the NFC-enabled device; sending, via the browser, a soft-POS instance launch request including the soft-POS identifier; receiving, via the browser, an interface for the soft-POS instance and a payment pin; activating a near field communication (NFC) element of the NFC-enabled device; receiving, via the NFC element of the NFC-enabled device, a card-present (CP) payment credential from a physical payment card; and sending, by the soft-POS instance, the CP payment credential and the transaction details associated with the online transaction to a payment network.

### BACKGROUND

A card-not-present (CNP) transaction is a purchase made remotely, without processing a physical card via a card reader or terminal (and without manually entering a PIN). CNP transactions are commonly used for online purchases when a customer buys goods on the Internet or through an e-commerce transaction.

However, because CNP transactions are processed without the customer or the credit card being physically present for verification, there is an increased risk for fraud. For example, CNP fraud is a type of credit card scam in which a defrauder uses someone else's compromised card information to make a remote purchase. Because neither the card nor the cardholder is physically present (and fraudsters often steal complementary information such as CVV and billing address), it can be difficult for merchants to verify the purchaser's identity.

While there are multiple guidelines for enabling safe online CNP transactions, card-present transactions are generally preferred for their benefits of increased security. Card-present (CP) transactions are transactions where the payment card details are captured in person, at the time of the sale. A card-present transaction occurs when a payment card is physically swiped, tapped, or dipped through a reader or if an EMV chip is processed. However, given the remote nature of an online transaction, currently, CP transactions are not enabled for users participating in an online transaction.

Therefore, systems and methods for enabling CP transactions for online transactions are desired to reduce the risk of fraud occurring in online transactions.

### BRIEF SUMMARY

Systems and techniques for converting card-not-present to card-present transactions for online transactions are described, which enable a physical payment card payment for an online transaction at an online merchant.

In some aspects, the techniques described herein relate to a method, including: capturing, via a NFC-enabled device, a QR code enabling a physical payment card payment for an online transaction at an online merchant, wherein the QR code includes a soft-point-of-sale (soft-POS) instance identifier with details including transaction details of the online transaction; decoding the QR code; and executing the soft-POS instance by: directing a browser to open on the NFC-enabled device; sending, via the browser, a soft-POS instance launch request including the soft-POS identifier; receiving, via the browser, an interface for the soft-POS instance and a payment pin; in response to receiving the payment pin, activating a near field communication (NFC) element of the NFC-enabled device; receiving, via the NFC element of the NFC-enabled device, a card-present (CP) payment credential from a physical payment card; and sending, by the soft-POS instance, the CP payment credential and the transaction details associated with the online transaction to a payment network.

In some aspects, the techniques described herein relate to a method, including: receiving, at a soft-point-of-sale (soft-POS) service, a soft-POS instance launch request from an NFC-enabled device for an online transaction at an online merchant; sending a soft-POS instance and a payment pin to a browser of the NFC-enabled device to execute the soft-POS instance via the browser of a NFC-enabled device and activate a near field communication (NFC) element of the NFC-enabled device, wherein the soft-POS instance includes transaction details of the online transaction; and receiving, at the soft-POS service, a card-present (CP) payment credential from a physical payment card from the NFC-enabled device.

In some aspects, the techniques described herein relate to a system including: a processing system; one or more storage media; and instructions stored on the one or more storage media that, when executed by the processing system, direct the processing system to at least: receive, at a soft-POS service, a card-not-present to card-present (CNP-to-CP) transaction type conversion request associated with an online transaction, wherein the CNP-to-CP transaction type conversion request requests to convert a transaction type for the online transaction from a CNP transaction to a CP transaction, and wherein the CNP-to-CP transaction type conversion request includes transaction details associated with the online transaction at an online merchant; in response to receiving the CNP-to-CP transaction type conversion request, generate, at the soft-POS service, a soft-POS instance associated with the online transaction; generate a QR code including a soft-POS instance identifier for the soft-POS instance associated with the online transaction; send the QR code including the soft-POS instance identifier to a user device, wherein the online transaction was initiated at the user device. receive, at a soft-point-of-sale (soft-POS) service, a soft-POS instance launch request from an NFC-enabled device for an online transaction at an online merchant; send a soft-POS instance and a payment pin to a browser of the NFC-enabled device to execute the soft-POS instance via the browser of the NFC-enabled device and activate an near field communication (NFC) element of the NFC-enabled device, wherein the soft-POS instance includes transaction details of the online transaction; and receive, at the soft-POS service, a card-present (CP) payment credential from a physical payment card from the NFC-enabled device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIGS. 1A-1D illustrate an example user experience for an online purchase.

FIG. 1E illustrates an example card-not-present (CNP) transaction process.

FIGS. 2A-2E illustrate an example user experience for a CNP-to-CP transaction for an online purchase at an online store checkout.

FIG. 3A illustrates a method of making a physical payment card payment for an online transaction at an online merchant from an NFC-enabled device.

FIG. 3B illustrates a process flow of the physical payment card payment for an online transaction at an online merchant from the NFC-enabled device.

FIG. 3C illustrates an example process for receiving CP credential.

FIG. 4A-4B illustrate example processes by a soft-POS service.

FIG. 4C illustrates an operating environment for the soft-POS service.

FIG. 5A illustrates components of a computing system that may be used to implement certain methods and services described herein.

FIG. 5B illustrates an example of an NFC-enabled device for making a physical card payment for an online transaction at an online merchant.

### DETAILED DESCRIPTION

Systems and techniques for converting card-not-present to card-present transactions for online transactions are described, which enable a physical payment card payment for an online transaction at an online merchant.

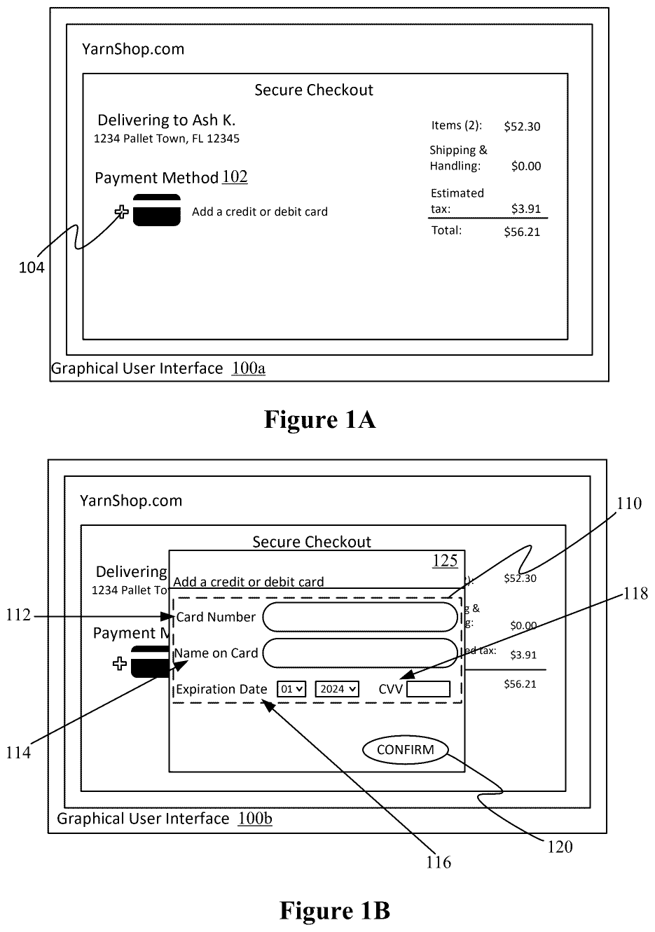

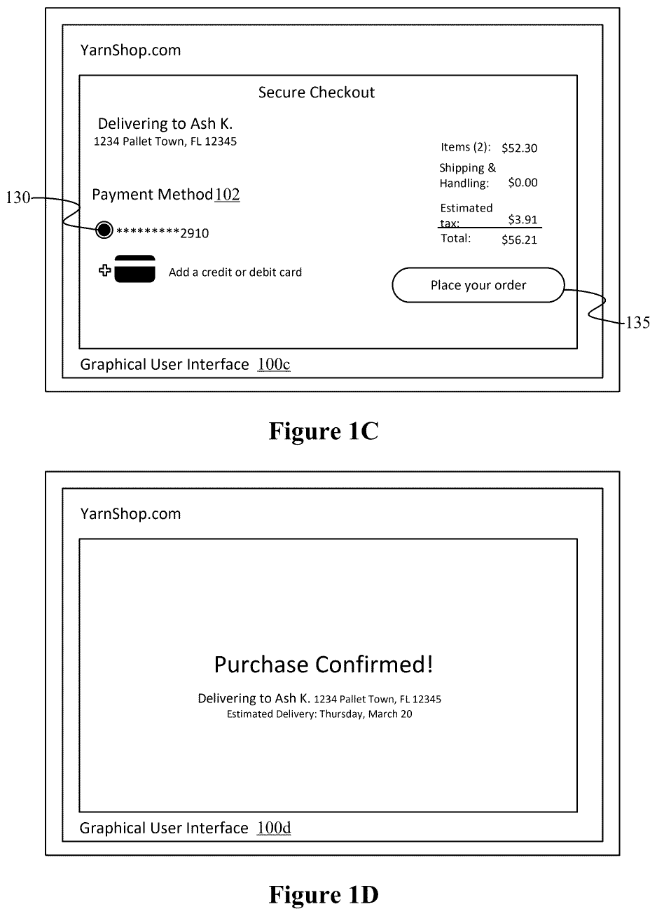

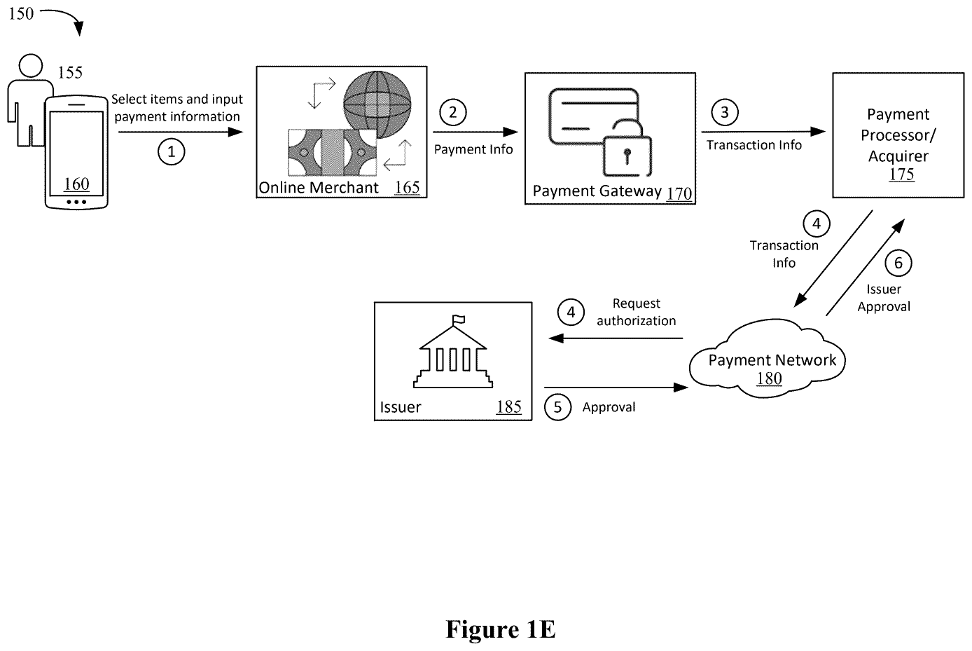

Traditionally, online transactions at an online merchant are CNP transactions. These CNP transactions typically involve a user entering their card payment details at checkout to enable payment for the transaction. An example is shown in FIGS. 1A-1E.

FIGS. 1A-1E illustrate an example user experience for an online purchase. The example user experience for an online purchase at online store checkout illustrated in FIGS. 1A-1E is an example of a CNP transaction. A CNP transaction is a purchase made remotely, without processing a physical card via a card reader or terminal (and without manually entering a PIN). CNP transactions are widely used in digital and remote transactions. Indeed, examples of CNP transaction methods include online shopping carts, manually entered orders over the phone, “buy” buttons on websites, recurring payments or subscription billings, payment applications that do not use a card reader, and electronic invoicing.

Referring to FIGS. 1A and 1E, as part of a typical CNP transaction flow 150, a user 155 accesses a “checkout” view 100a in a graphical user interface (GUI) for an online merchant 165, for example, using a user device 160 (e.g., mobile device, computing device, etc.). At the “checkout” view 100a, the user 155 is prompted to add a payment method 102 to use for the online transaction. Here, the user 155 adds a payment method 102 by selecting the “add a credit or debit card” button 104.

As shown in GUI view 100b, in response to the selection of the “add a credit or debit card” button 104 at GUI view 100a, a pop-up window 125 is generated, prompting the user 155 to enter payment card details 110 corresponding to a preferred credit or debit card. The payment card details 110 can include a card number 112, a name on the card 114, an expiration date 116, and a card verification value (CVV) 118. Once the user 155 has entered the payment card details 110 in the pop-up window 125 at GUI view 100b of the online store, the user 155 can select the “confirm” button 120 to proceed with the checkout process.

GUI view 100c illustrates the “checkout” view that has been updated to include a payment method 102. At the final checkout view of GUI 100c, the user 155 has selected the payment method 102 of “*********2910” 130 (e.g., corresponding to the payment card details 110 entered in pop-up window 125 of GUI view 100b) for this online transaction. Once the user 155 selects the “place your order” button 135, the online store will process the payment, as described with respect to FIG. 1E, and display purchase confirmation in GUI view 100d.

In detail, with reference to FIG. 1E, CNP transaction flow 150 can begin at step (1), where the user 155, via device 160, selects items to add to their online shopping cart at the online merchant 165 and enters payment card details 110 for check-out (e.g., as illustrated in GUI views 100a-100c). In some cases, because this is a CNP transaction, the check-out process of step (1) can include a one-time-password (OTP) or other verification step for additional authentication of the user 155. The payment information can include a bank identification number (BIN) (or “card number”), CVV, expiration date, cardholder name, and cardholder address. The online merchant 165 can utilize a payment gateway 170, which allows the online merchant 165 to accept debit or credit card purchases.

As shown at step (2), the payment gateway 170 receives the payment information of the user 155 via the online merchant 165, for example, when user 155 enters payment card details 110 as shown in GUI view 100b of FIG. 1B.

Once the customer finalizes the transaction and selects the “place your order” button 135 in GUI view 100c, the payment gateway 170 can securely transmit the transaction information to a payment processor/acquirer 175, as shown in step (3). The transaction information can include, but is not limited to, the payment card details 110, merchant identifier, and transaction total. A payment processor is a company or service that facilitates electronic transactions—such as payments made with credit cards, debit cards, or digital wallets—between businesses and their customers.

Then, at step (4), the payment processor/acquirer 175 can send the transaction information (including the payment information) to a payment network 180 (e.g., card network) for verification of the customer's 155 payment information.

Upon verification, the payment network 180 can request authorization for the release of funds from the issuer 185. If the issuer 185 confirms that the customer has sufficient funds to pay for the online order, the issuer 185 can send a response to the payment network 180 to approve the transaction, as shown in step (5).

Once the approval signal is received, the payment network 180 can forward the signal to the payment processor/acquirer 175. The payment processor/acquirer 175 can forward the signal to the online merchant 165 to confirm the transaction has been accepted. Later on, settlement and clearing can occur. In clearing, the payment information can be double checked for accuracy. In settlement, the issuer 185 can transfer funds to the payment network 180; the payment network 180 can then transfer the funds to the payment processor/acquirer 175. Once the payment processor/acquirer 175 receives the funds, the funds can be made available to the online merchant 165.

Unfortunately, because CNP transactions are processed without the user or the payment card being physically present for verification, there is an increased risk for fraud. The business (e.g., online merchant) must rely on the correct entry of necessary card details to process the payment, as opposed to the physical card being presented at the time of payment. The risk of fraud is higher due to the lack of physical card verification.

For example, consider the following hypothetical. If a fraudster has access to the user's payment card details (e.g., payment details 110 as described with respect to FIGS. 1A-1D), an online transaction at an online merchant (e.g., as described with respect to FIGS. 1A-1E) could be completed in an identical manner by the fraudster. While certain security protocol may be in place, for example, use of a one-time-password (OTP) for verification during the check-out process, fraudsters often have methods to circumvent these protections.

A card-present (CP) transaction refers to a payment method in which the cardholder presents the physical credit or debit card at the point of sale. Beyond just the physical presence of the credit card, a transaction is categorized as a CP transaction only when electronic data is captured at the point of sale. Traditionally, this occurs in a brick-and-mortar store, where the user either swipes, dips, or taps their card at a card reader or point-of-sale (POS) terminals. CP transaction methods include countertop card machines, contactless terminals, POS systems equipped with card readers, and card readers connected to smartphones or tablets. Currently, CP transactions are not performed for online transactions at a virtual checkout at an online merchant.

Advantageously, the described systems and methods enable CP transactions using a physical payment card as payment for an online purchase at an online merchant.

As described in detail herein, a soft-POS service is provided that can generate a soft-POS instance at a user device during a virtual checkout to enable users to use a physical payment card payment (e.g., CP transaction) for an online transaction at an online merchant. The soft-POS instance can be a replica of a physical POS system, including details and regulatory requirements included in physical POS systems. However, unlike physical POS systems, the soft-POS instance is accessible to a user via a browser on their mobile device. This allows merchants to require a card-present transaction even when the user is not physically present to use a merchant terminal since users are now able to simply tap a physical payment card at their mobile device to complete an online transaction. Advantageously, this increases the security of online transactions by reducing the likelihood of fraudulent payment card activity that increases with CNP transactions.

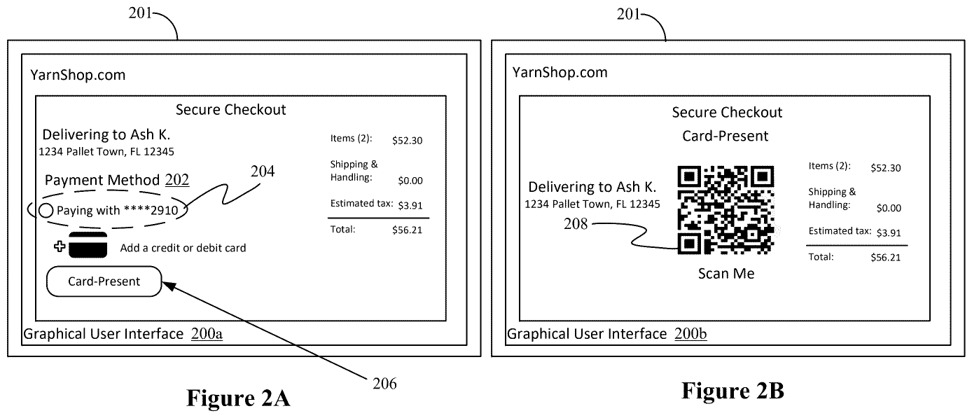

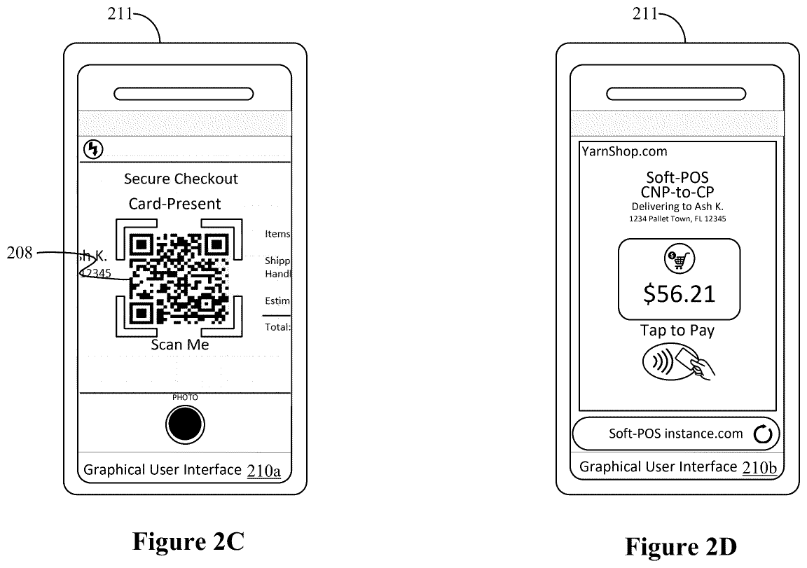

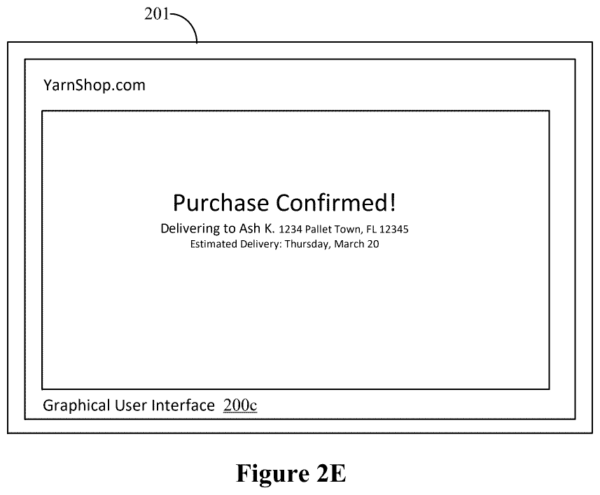

FIGS. 2A-2E illustrate an example user experience for a CNP-to-CP transaction for an online purchase at an online store checkout.

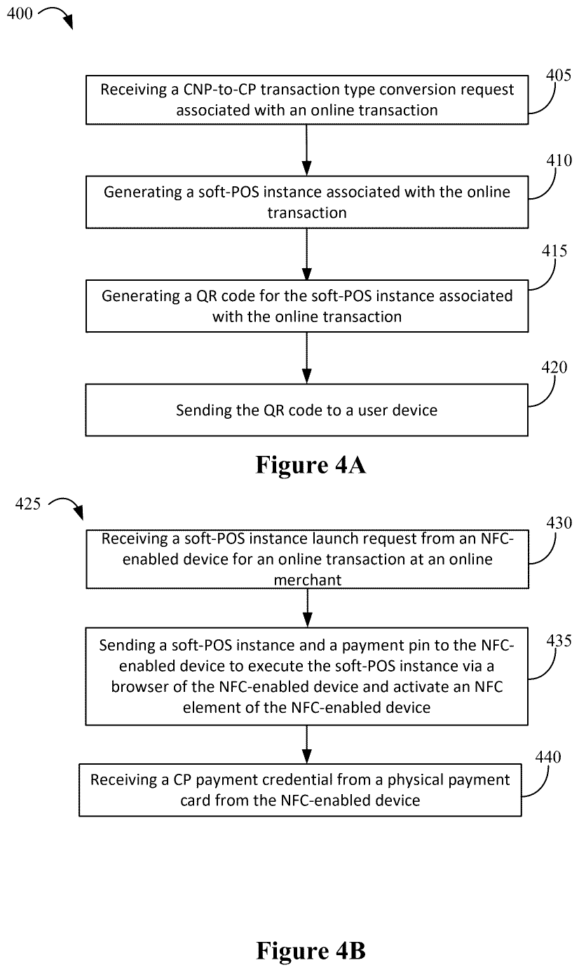

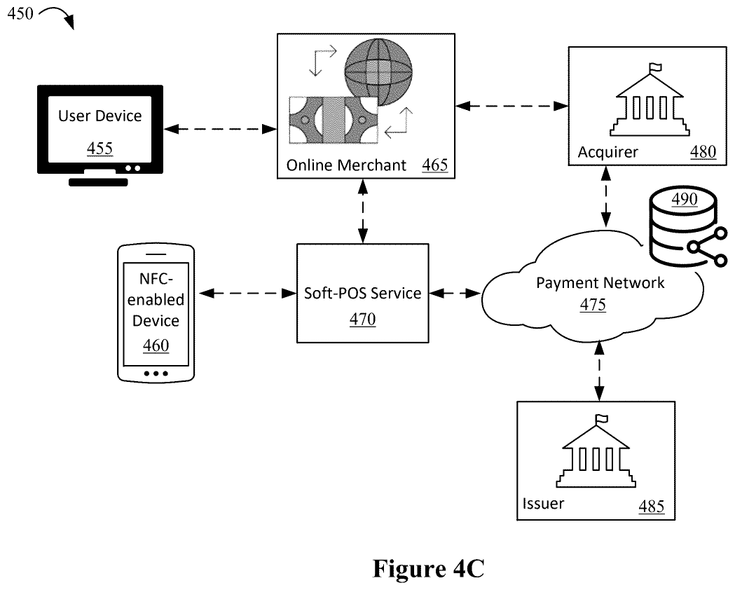

Referring to FIGS. 2A-2B, a user can access a “checkout” view 200a in a GUI for an online store, for example using a user device 201 (e.g., mobile device, computing device, smartphone, gaming device, tablet, and the like). At the “checkout” view 200a, the user can select a preferred payment method 202 to use for the purchase. In contrast to the experience described with respect to FIGS. 1A-1D, the user can be provided with an option to pay with a physical payment card by selecting the “card-present” button 206, instead of using (or adding) the card-on-file 204. When the user selects the “card-present” button 206, a CNP-to-CP transaction flow is initiated. In some cases, the CNP-to-CP transaction flow can follow that described with respect to FIGS. 4A-4C.

As shown in FIG. 2B, the secure checkout screen of GUI view 200b displays a quick-response (QR) code 208 on the user device 201 that enables a physical payment card payment for the online transaction. The QR code includes a soft-POS instance identifier with details including the transaction details of the online transaction (e.g., delivery address, item total, user information, etc.). The user can use a proximity communication device (e.g., NFC-enabled device 211 of FIGS. 2C and 2D) to capture the QR code and launch the soft-POS instance to enable payment via a physical payment card.

Referring to FIG. 2C, the GUI view 210a displayed at the NFC-enabled device 211 shows the camera view of a camera of the NFC-enabled device 211 (e.g., mobile device, computing device, smartphone, gaming device, tablet, and the like), which is providing an image of the display of the secure check-out screen view 200b from the user device 201 as shown in FIG. 2B. The NFC-enabled device 211, via the camera, can capture the QR code displayed in GUI view 200b at the user device 201.

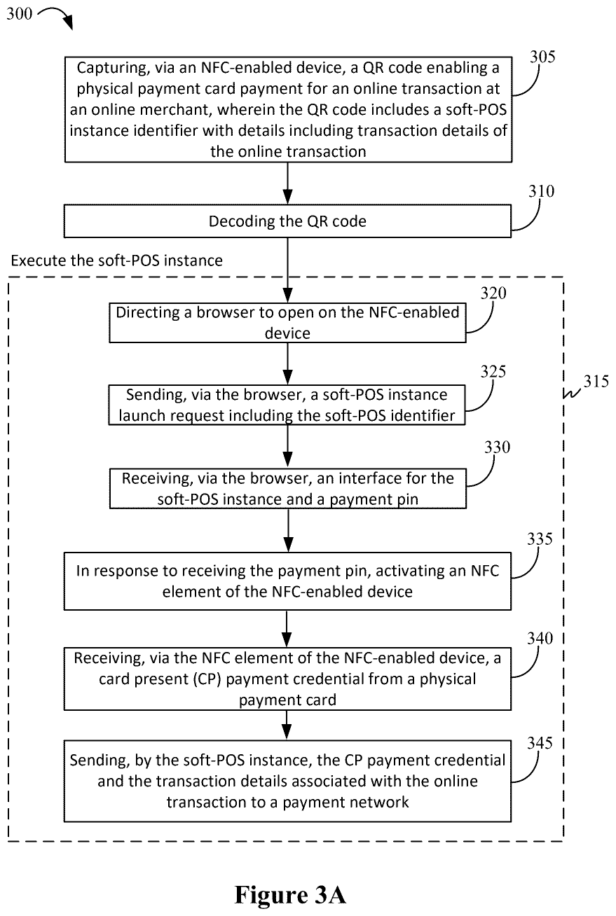

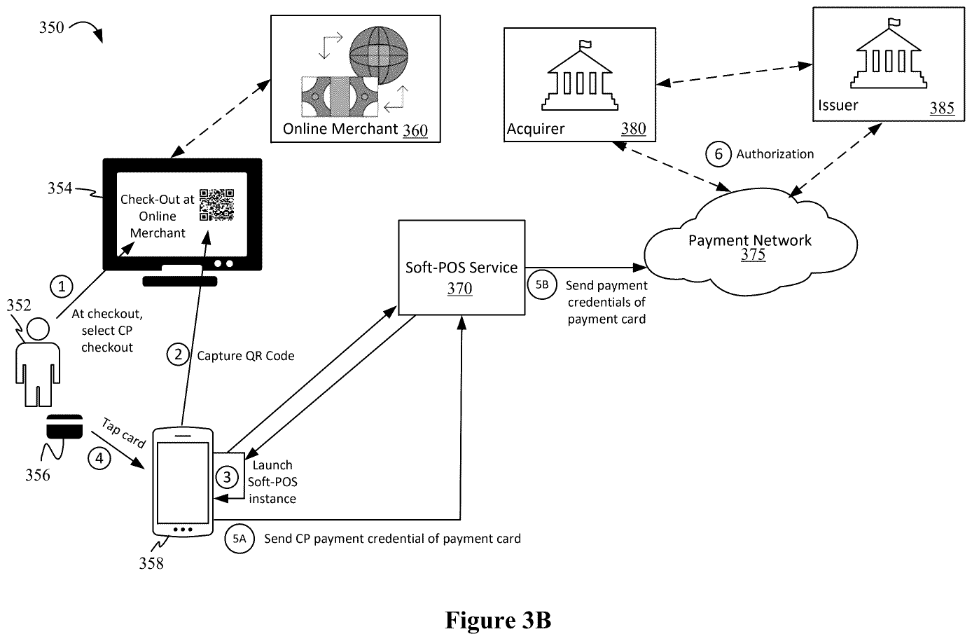

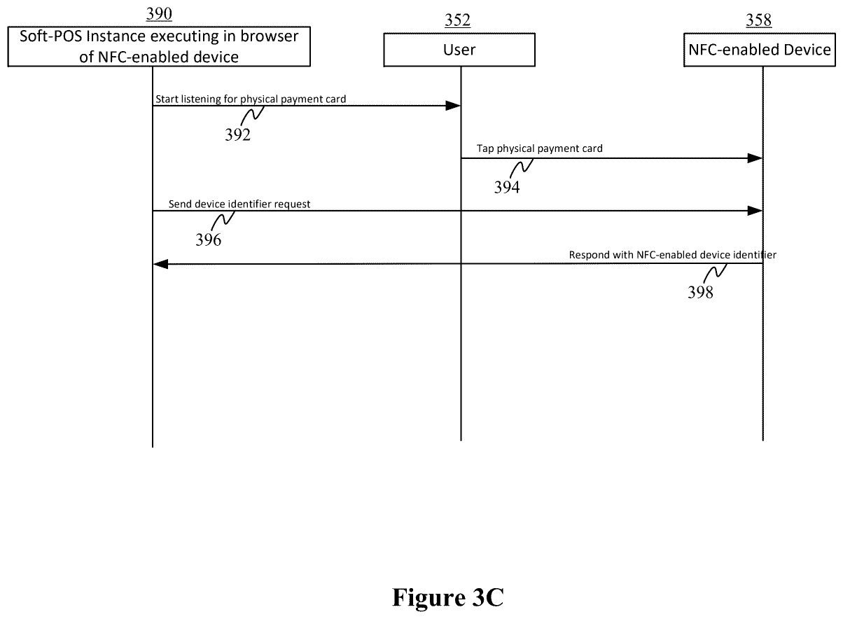

Once the NFC-enabled device 211 captures the QR code displayed at GUI view 200b, the NFC-enabled device 211 can decode the QR code and execute the soft-POS instance included in the QR code (e.g., as described in more detail with respect to FIGS. 3A-3B).

Referring to FIG. 2D, upon scanning the QR code and executing the soft-POS instance contained in the QR code, the NFC-enabled device 211 displays an interface for the soft-POS instance in GUI view 210b. The soft-POS instance enables the user to complete a CP transaction using a proximity communication device, for example a Near Field Communication (NFC) or other proximity communication protocol device. As prompted in GUI view 210b, the user can tap their physical payment card at the NFC-enabled device 211 to complete payment for the secure checkout of the online transaction initiated at the user device 201 (e.g., as reflected in GUI views 200a and 200b of FIGS. 2A-2B).

Referring to FIG. 2E, GUI view 200c displays a confirmation at the user device 201 that the CNP-to-CP payment facilitated at the NFC-enabled device 211 was approved and the original online transaction has been completed.

FIG. 3A illustrates a method of making a physical payment card payment for an online transaction at an online merchant from an NFC-enabled device; and FIG. 3B illustrates a process flow of the physical payment card payment for an online transaction at an online merchant from the NFC-enabled device. Referring to FIGS. 3A-3B, a process 350 of a physical payment card payment for an online transaction at an online merchant from a user device can begin when a user 352, selects, at a user device 354, the option to pay with a physical payment card 356 (e.g., a card-present transaction) for an online transaction at an online merchant 360, as shown in step (1).

To support the payment via physical payment card 356, the user device 354 can display a QR code (see e.g., FIG. 2B). The QR code includes a soft-POS instance identifier with details including transaction details of the online transaction initiated at the user device 354. In some cases, a mixed CNP/CP flag indicating that the transaction type of the online transaction is a CNP-to-CP transaction type can be embedded in the QR code. Details of an implementation for providing the QR code with a soft-POS instance are described in detail with respect to FIGS. 4A-4C. In some cases, the transaction details can include user details (e.g., name, address, user login information, etc.), transaction total, transaction time stamps, a mixed CNP/CP flag, merchant information (e.g., merchant identifier, merchant category code, etc.), acquirer details, and a device identifier (e.g., associated with the user device 354). In some cases, the QR code can be a time limited QR code. In some cases, the soft-POS instance itself can be time-limited which can improve security.

In some cases, the QR code can further include a web installer for installing the soft-POS instance at a browser of the NFC-enabled device 358. In some cases, the QR code can also include the transaction details.

Once the QR code is made available for use supporting payment via physical payment card 356, method 300 of FIG. 3A can be carried out by NFC-enabled device 358, including, capturing (305), via an NFC-enabled device, a QR code enabling a physical payment card payment for an online transaction at an online merchant, wherein the QR code includes a soft-POS instance identifier with details including transaction details of the online transaction; decoding (310) the QR code; and executing (315) the soft-POS instance by: directing (320) a browser to open on the NFC-enabled device; sending (325), via the browser, a soft-POS instance launch request including the soft-POS identifier; receiving (330), via the browser, an interface for the soft-POS instance and a payment pin; in response to receiving the payment pin, activating (335) an NFC element of the NFC-enabled device; receiving (340), via the NFC element of the NFC-enabled device, card-present (CP) payment credential from a physical payment card; and sending (345), by the soft-POS instance, the CP payment credential and the transaction details associated with the online transaction to a payment network.

In detail, with reference to FIG. 3B, at step (2), the user 352, via the NFC-enabled device 358, captures (305) the QR code enabling a physical payment card payment for the online transaction at the online merchant. In some cases, capturing (305) the QR code can include capturing (305) via a camera device of the NFC-enabled device 358, the QR code displayed at the user device 354, where the online transaction was initiated (see e.g., FIGS. 2A-2C).

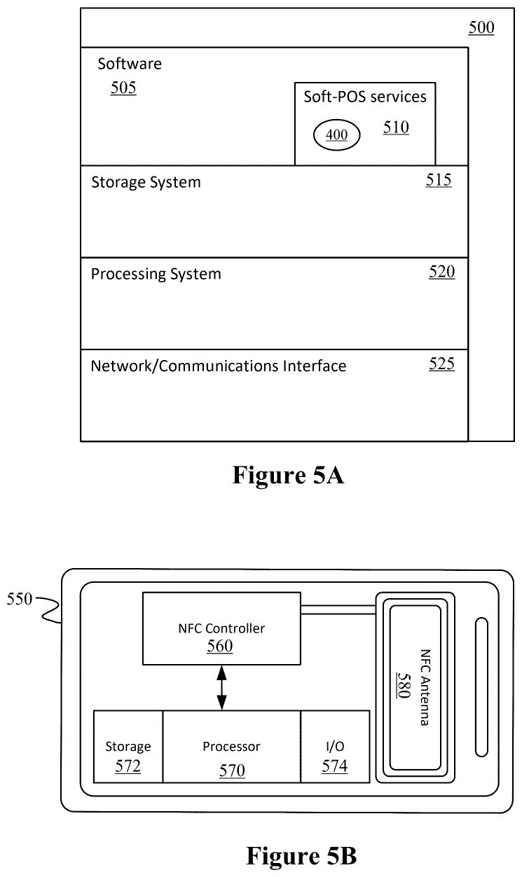

The NFC-enabled device 358 can be an NFC-enabled device (see e.g., NFC-enabled device 550 described with respect to FIG. 5B) or can be coupled to (e.g., via a wired connection) a device that includes NFC functionality. In addition, the NFC-enabled device 358 includes a camera and has network capabilities (e.g., cellular, WiFi, etc.).

It should be understood that while two devices are described in the illustrated implementations, it is possible to conduct the online transaction and perform the card-present operation from a same device, for example, where the device displaying the QR code has a ‘live detection’ capability that detects a QR code from a video or image being displayed at that device.

In response to capturing (305) the QR code at step (2), at step (3) the NFC-enabled device 358 can decode (310) the QR code and launch the soft-POS instance associated with the soft-POS instance identifier included in the QR code. Launching the soft-POS instance can include executing (315) the soft-POS instance by directing (320) a browser to open on the NFC-enabled device 358, sending (325), via the browser, a soft-POS instance launch request to the soft-POS service 370 including the soft-POS identifier, and receiving (330), from the soft-POS service 370, via the browser, an interface for the soft-POS instance and a payment pin.

The soft-POS service 370 enables the CP-to-CNP transaction by generating, supporting, and providing user access to a soft-POS instance to facilitate the CP transaction for an online transaction.

In response to receiving the payment pin, the NFC-enabled device 358 activates (335) an NFC element of the NFC-enabled device 358. Activating (335) the NFC element of the soft-POS instance can initiate the process for receiving CP payment credential where the soft-POS instance starts “listening” (i.e., waits for an appropriate signal) for the payment card. In some cases, the soft-POS instance on the NFC-enabled device 358 is time enabled and can close after a predefined time period in case no signal is detected.

Once the NFC-enabled device 358 launches the soft-POS instance in the browser, the user 352 can tap their physical payment card 356 at the NFC-enabled device 358, as shown in step (4). The NFC element of the NFC-enabled device 358 can receive (340) the CP payment credential from the physical payment card 356. An example process for receiving CP credential from a physical payment card is described with respect to FIG. 3C.

Method 300 can further include obtaining an NFC-enabled device identifier of the NFC-enabled device 358 during the executing (315) of the soft-POS instance.

In response to receiving the CP payment credential from the physical payment card 356, the NFC-enabled device 358 can send (345), by the soft-POS instance, the CP payment credential and the transaction details associated with the online transaction to the payment network 375.

In some cases, sending (345), by the soft-POS instance, the CP payment credential and the transaction details can include sending the mixed CNP/CP flag. In some cases, the CP payment credential, transaction details, and/or the mixed CNP/CP flag can be in an ISO message format (e.g., ISO 8583 message, ISO 20022, etc.). The ISO message format can include a field indicating the method by which the cardholder's data was captured (e.g., CP transaction or a CNP transactions) (e.g., Field 22: Point of Service Entry Mode). For example, in a CNP transaction, the ISO message can include a CNP indicator in a field. For CP transactions, the ISO message may include a CP indicator (e.g., indicator 07: Contactless chip (NFC) transaction).

For CNP-to-CP transactions, a mixed CNP/CP flag is included to indicate that the transaction began as a CNP transaction and is completed as a CP transaction (e.g., via contactless chip).

In some cases, sending (345), by the soft-POS instance, the CP payment credential includes sending an NFC-enabled device identifier associated with the NFC-enabled device 358.

In some cases, the soft-POS instance at the NFC-enabled device 358 sends the transaction details to the payment network 375 via the soft-POS service 370. For example, the soft-POS service 370 can receive, by the soft-POS instance, the CP payment credential, the transaction details, the mixed CNP/CP flag, and the NFC-enabled device identifier associated with the NFC-enabled device 358 and forward them to the payment network 375. In some cases, the soft-POS service 370 is part of the payment network 375.

In some cases, the method 300 can further include displaying, at the interface for the soft-POS instance at the NFC-enabled device 358, a personal identification number (PIN) entry request prompting the user 352 to enter a PIN associated with the physical payment card. In response to receiving, at the interface for the soft-POS instance at the NFC-enabled device 358, the PIN entry request, the user 352 can enter a PIN at the interface of the soft-POS instance displayed on the NFC-enabled device 358. The NFC-enabled device 358 receives the PIN entered at the interface of the soft-POS instance and can send, via the soft-POS instance, the entered PIN to the soft-POS service 370. The soft-POS service 370 can send the PIN, along with the CP payment credential, the transaction details, and an NFC-enabled device identifier associated with the NFC-enabled device 358 to the payment network 375.

In response to receiving the CP payment credential from the soft-POS service 370. payment network 375 can communicate with the issuer 385 to authorize the online transaction. The payment network 375 can send notifications of issuer 385 approval to the acquirer 380.

In some cases, method 300 can further include receiving, by the soft-POS instance executing in the browser of the NFC-enabled device 358, confirmation of approval of the online transaction and in response to receiving confirmation of approval of the online transaction, closing the soft-POS instance at the NFC-enabled device 358, which can improve security.

FIG. 3C illustrates an example process for receiving CP credential.

Referring to FIGS. 3A-3C, the soft-POS instance 390 executing in the browser of the NFC-enabled device 358 can start (392) “listening” for the physical payment card. The user 352 can tap (394) the physical payment card 356 at the NFC-enabled device 358.

The physical payment card 356 can be embedded with a small computer chip, such as an EMV (Europay, Visa, and Mastercard) chip, that can transmit payment data to a card reader during a transaction (e.g., via dip or tap methods, depending on capabilities of the circuit on the chip). During a CP payment transaction, the EMV chip of the physical payment card 356 does not transmit the physical payment card's 356 real number during the transaction. Instead, a unique code is generated for every purchase and that code is sent to the card reader (e.g., CP payment credential). Advantageously, the code generated by the EMV chip cannot be replicated, used more than once, or easily faked—protecting EMV cards from the security vulnerabilities associated with CNP transactions.

In some cases, the physical payment card 356 EMV chip can also include card acceptor device ID data element. The card acceptor device ID data element can be a device object list (DOL)_ object used to facilitate the exchange of an NFC-enabled device identifier associated with the NFC-enabled device with the soft-POS instance. The card acceptor device ID data element can trigger the receiving chip reader soft-POS instance to prompt the user device executing the soft-POS instance to request a device ID.

In response to the physical payment card being tapped at the NFC-enabled device 358, the soft-POS instance 390 executing in the browser of the NFC-enabled device 358 can obtain an NFC-enabled device identifier of the NFC-enabled device 358. In some cases, obtaining an NFC-enabled device identifier of the NFC-enabled device 358 can include sending (396), from the soft-POS instance 390 executing in the browser of the NFC-enabled device 358, a device identifier request requesting a device identifier from the NFC-enabled device 358. For example, in some cases, the soft-POS instance 390 executing in the browser of the NFC-enabled device 358 can send (396) a device identifier request to an operating system of the NFC-enabled device 358.

In some cases, obtaining an NFC-enabled device identifier of the NFC-enabled device 358 can include the NFC-enabled device 358 responding (398) to the device identifier request by providing an NFC-enabled device identifier associated with the NFC-enabled device 358 to the soft-POS instance 390 executing in the browser of the NFC-enabled device 358. The soft-POS instance 390 executing in the browser of the NFC-enabled device 358 can send the NFC-enabled device identifier associated with the NFC-enabled device 358 to the soft-POS service 370.

FIG. 4A-4B illustrate example processes by a soft-POS service. FIG. 4C illustrates an operating environment for the soft-POS service.

Referring to FIGS. 4A-4C, similar to that described with respect to operating environment of process 350 of FIG. 3B, operating environment 450 can include a user device 455, an NFC-enabled device 460, an online merchant 465, a soft-POS service 470, a payment network 475, an acquirer 480, and an issuer 485. Soft-POS service 470 can be implemented by a computing system that communicates with or is a part of a system on payment network 475. Soft-POS service 470 provides services for creating a soft-POS instance that can be accessed via browser at a user device (e.g., NFC-enabled device 460) and used to make a physical payment card payment (e.g., CP transaction) for an online transaction at an online merchant. Soft-POS service 470 can facilitate a physical payment card payment for an online transaction at the online merchant 465 by performing method 400.

Method 400 includes receiving (405) a CNP-to-CP transaction type conversion request associated with an online transaction; generating (410) a soft-POS instance associated with the online transaction; generating (415) a QR code including a soft-POS instance identifier for the soft-POS instance associated with the online transaction; and sending (420) the QR code including the soft-POS instance identifier to a user device.

Method 425 includes receiving (430) a soft-POS instance launch request from a user device for an online transaction at an online merchant; sending (435) a soft-POS instance and a payment pin to the user device to execute the soft-POS instance via a browser of the user device and activate an NFC element of the user device; and receiving (440) the CP payment credential from a physical payment card from the user device.

In detail, soft-POS service 470 can receive (405) a CNP-to-CP transaction type conversion request for an online transaction at online merchant 465. The CNP-to-CP transaction type conversion request can be triggered as a result of a checkout request from a user device 455 through which a user is making a purchase at an online merchant 465 (see e.g., FIG. 2A). The CNP-to-CP transaction type conversion request requests to convert a transaction type for the online transaction from a CNP transaction to a CP transaction. Accordingly, the CNP-to-CP transaction type conversion request can include transaction details of the online transaction being carried out, for example, at user device 455, which can include, but is not limited to, user details, a merchant identifier, time stamps, acquirer details, and transaction total. In some cases, the soft-POS service 470 receives (405) a CNP-to-CP transaction type conversion request from the acquirer 480 (e.g., via a payment gateway) associated with the online merchant 465. Acquirer 480 may be used to send the CNP-to-CP transaction type conversion request to the soft-POS service 470 over the payment network 475. In some cases, the soft-POS service 470 receives (405) the CNP-to-CP transaction type conversion request from the online merchant 465 directly (e.g., as part of a registered account) or via a third party access to the soft-POS service 470.

In response to receiving (405) the CNP-to-CP transaction type conversion request for an online transaction, the soft-POS service 470 can generate (410) a soft-POS instance associated with the online transaction. The soft-POS instance is a running process being executed by a processor on a computing system (e.g., on a virtual machine) associated with the soft-POS service 470. The soft-POS instance may be considered to be a virtual point of sale device. In some cases, the soft-POS instance can include the transaction details provided by the online merchant 465 that is the source of the CNP-to-CP request. In some cases, the transaction details include user details (e.g., name, address, user login information, etc.), transaction total, transaction time stamps, merchant information (e.g., merchant identifier, merchant category code, etc.), acquirer details, a device identifier (e.g., associated with the user device 455), and combinations thereof. The soft-POS instance can be time bound (e.g., includes a time constraint requiring action within a particular amount of time before expiring).

The soft-POS service 470 can generate (415) a QR code including a soft-POS instance identifier for the soft-POS instance associated with the online transaction. In some cases, the soft-POS instance identifier is encoded as a URL to an endpoint access for the soft-POS service 470. In some cases, the QR code also encodes the transaction details. The soft-POS service 470 may directly generate the QR code or communicate (e.g., via an application programming interface) with a service that performs the steps to encode the information and generate the QR code.

In some cases, the QR code can also include a mixed CNP/CP flag indicating that a transaction type of the online transaction is a CNP-to-CP transaction type (e.g., via an ISO tag of an ISO message). The mixed CNP/CP flag indicates that the online transaction associated with the mixed CNP/CP flag is assigned a higher level of trust for authorization purposes as compared to other online transactions, because the transaction is paid for via a physical payment card as a CP transaction. In some cases, the mixed CNP/CP flag is only (set and) stored at a system associated with the soft-POS service as a result of two different devices (as indicated by device identifiers included in the requests to the soft-POS service) being involved in the transaction.

In response to generating (415) the QR code including the soft-POS instance associated with the online transaction, the soft-POS service 470 can send (420) the QR code to the user device 455 (e.g., via the payment gateway of the online merchant 465), for example, as illustrated and described with respect to FIG. 2B). The QR code may be sent as one or more images (with the one or more images in one or more image formats such as PNG, JPG, SVG, and EPS)

After the QR code is available for the online merchant 465, an NFC-enabled device 460 can perform method 300 as described with respect to FIGS. 3A-3B. As mentioned above, it should be understood that while two devices are described in the illustrated implementations, it is possible to conduct the online transaction and perform the card-present operation from a same device (e.g., user device 455 and NFC-enabled device 460 are the same device which has capabilities to live capture a QR code from its own display).

With the NFC-enabled device 460 performing method 300, the soft-POS service 470 performs operations such as follows. For example, the soft-POS service 470 can receive (430) the soft-POS instance launch request from NFC-enabled device 460 for the online transaction at the online merchant 465 as a result of the NFC-enabled device 460 executing steps to access the soft-POS instance provided in the decoded QR code generated by the soft-POS service 470 for an online transaction between the user and the online merchant 465.

In response to receiving (430) the soft-POS instance launch request from the NFC-enabled device 460, the soft-POS service 470 can send (435) a soft-POS instance and a payment pin to the NFC-enabled device 460 to execute the soft-POS instance via a browser of the NFC-enabled device 460 and activate an NFC element of the NFC-enabled device 460 so as to capture CP payment credential from a physical payment card. The payment pin can be a time-bound payment pin that enables permissions to be authorized for capturing the CP payment credential from the physical payment card, which can improve security.

The soft-POS service 470 can receive (440) the CP payment credential from the NFC-enabled device 460. For example, a user can tap (or otherwise bring within appropriate distance) their physical payment card at NFC-enabled device 460, and the NFC-enabled device 460 can capture CP payment credential from the physical payment card via the NFC element of the NFC-enabled device 460. The NFC-enabled device 460 sends the CP payment credential to the soft-POS service 470, which receives the CP payment credential through the soft-POS instance activated in the NFC-enabled device 460. In some cases, the NFC-enabled device 460 sends an NFC-enabled device identifier associated with the NFC-enabled device 460 to the soft-POS service 470, which receives the NFC-enabled device identifier associated with the NFC-enabled device 460 through the soft-POS instance activated in the NFC-enabled device 460.

At the system associated with the soft-POS service 470, device identifiers for the user device 455 and the NFC-enabled device 460 can be stored against the transaction, which shows the transaction was forked and the initiation of the transaction was performed online using the user device 455 whereas the payment was initiated physically using a soft-POS instance generated on a NFC-enabled device 460. Alternatively, or in addition, a CNP/CP transaction flag can be stored. The payment completed information and transaction details (e.g., as described with respect to information provided for the soft-POS instance) can further be mapped to the online merchant 465, enabling notifications to be sent to the online merchant 465.

In some cases, additional layers of security are possible. For example, the soft-POS service 470 can send a PIN entry request to the soft-POS instance at the NFC-enabled device 460 and receive a PIN entered by a user at the NFC-enabled device 460.

To complete a transaction, after receiving (440) the CP payment credential (and optionally the PIN or a confirmation that a valid PIN was entered), the soft-POS service 470 can send the CP payment credential to the payment network 475. The payment network 475 can request authorization for the release of funds from the issuer 485. In some cases, the authorization request for release of funds can include the mixed CNP/CP transaction flag indicating that the transaction was a CP transaction, the

If the issuer 485 confirms that the customer has sufficient funds to pay for the online order, the issuer 485 can send a response to the payment network 475 to approve the transaction. In some cases, the soft-POS service 470 is part of the payment network 475, and the soft-POS service 470 can facilitate authorization of the CP payment credential with the issuer 485.

Once the approval signal is received, the payment network 475 can forward the signal to the soft-POS service 470. The soft-POS service 470 can forward the signal to the online merchant 465 to confirm the transaction has been accepted. In some cases, the signal to confirm the transaction can include payment information (e.g., CP payment credential). In some cases, the soft-POS service 470 can fork the confirmation message flow, sending a first message to the online merchant 465 and sending a second message to the issuer 485.

Later on, settlement and clearing can occur. In clearing, the payment information can be double checked for accuracy. In settlement, the issuer 485 can transfer funds to the payment network 475; the payment network 475 can then transfer the funds to the acquirer 480. Once the payment processor/acquirer 480 receives the funds, the funds can be made available to the online merchant 465.

The payment network 475 can include or communicate with a storage resource 490 that stores the CNP-to-CP transaction information, including transaction information included in the QR code/soft-POS instance, the mixed CNP/CP transaction flag, and device identifiers (IDs) associated with the CNP-to-CP transaction (e.g., device ID associated with the user device 455 and the NFC-enabled device 460). Such information may be stored for retention and settlement. Storage resource 490 may be accessible by soft-POS service 470.

The mixed CNP/CP transaction flag indicates that, although the transaction began as a CNP transaction at an online merchant, the transaction was a CP transaction. Advantageously, the mixed CNP/CP transaction flag identifies that this transaction can be assigned a higher level of trust for authorization/fraud purposes. Indeed, because the CP payment credential include a EMV code generated by a physical payment card, there is a higher level of confidence that the transaction is an authentic transaction.

The stored device IDs indicate that the transaction was forked (e.g., first leg of transaction was initiated at user device 455 and the transaction was completed on the NFC-enabled device 460).

FIG. 5A illustrates components of a computing system that may be used to implement certain methods and services described herein. Referring to FIG. 5A, system 500 may be implemented within a single computing device or distributed across multiple computing devices or sub-systems that cooperate in executing program instructions. The system 500 can include one or more blade server devices, standalone server devices, personal computers, routers, hubs, switches, bridges, firewall devices, intrusion detection devices, mainframe computers, network-attached storage devices, and other types of computing devices.

The system 500 can include a processing system 520, which may include one or more processors and/or other circuitry that retrieves and executes software 505 from storage system 515. Processing system 520 may be implemented within a single processing device but may also be distributed across multiple processing devices or sub-systems that cooperate in executing program instructions.

Examples of processing system 520 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof.

Storage system 515 can include any computer readable storage media readable by processing system 520 and capable of storing software 505 and data. Storage system 515 may be implemented as a single storage device but may also be implemented across multiple storage devices or sub-systems co-located or distributed relative to each other. Storage system 515 may include additional elements, such as a controller, capable of communicating with processing system 520.

Software 505 may be implemented in program instructions and among other functions may, when executed by system 500 in general or processing system 520 in particular, direct the system 500 or processing system 520 to operate as described herein for facilitating a physical payment card payment for an online transaction at an online merchant. For example, software 505 may provide program instructions that implement method 400 or other operations described with respect to FIG. 4C.

Software 505 may also include additional processes, programs, or components, such as operating system software or other application software. Software 505 may also include firmware or some other form of machine-readable processing instructions executable by processing system 520.

A communication interface 525 may be included, providing communication connections and devices that allow for communication between system 500 and other computing systems (e.g., including user device 354 and NFC-enabled device 358 described with respect to FIGS. 3A-3B and user device 455 and NFC-enabled device 460 described with respect to FIGS. 4A-4C) over a communication network or collection of networks (not shown) or the air.

Communication to and from client computing devices, beacons, and other computing systems (not shown) and the soft-POS instance 510 may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

FIG. 5B illustrates an example of an NFC-enabled device for making a physical card payment for an online transaction at an online merchant. Referring to FIG. 5B, the NFC-enabled device 550 includes an NFC element including an NFC controller 560 and NFC antenna 580. Other components of NFC enabled device 550 can include a processor 570, storage 572, an input/output (I/O) interface 574 and an NFC antenna 580. NFC transmissions are short range (from a touch to a few centimeters) and require the devices to be in close proximity. NFC is a set of communication protocols that enables communication between two electronic devices over a distance of 4 cm or less.

The NFC-enabled device 550 can be a computing device, for example (e.g., user device 354 and NFC-enabled device 358 described with respect to FIGS. 3A-3B, user device 455 and NFC-enabled device 460 described with respect to FIGS. 4A-4C). The NFC-enabled device 550 may represent a computing device such as, but not limited to, a personal computer, a reader, a mobile device, a personal digital assistant, a wearable computer, a smart phone, a tablet, a laptop computer (notebook or netbook), a gaming device or console, an entertainment device, a hybrid computer, a desktop computer, or a smart television.

The processor 570 can include of one or more processors to transform or manipulate data according to the instructions of software stored on a storage 572. Examples of processors of the processor 570 can include general purpose central processing units, application specific processors, and logic devices, as well as any other type of processing device, combinations, or variations thereof.

The storage 572 may comprise any computer readable storage media readable by the processor 570 and capable of storing software. Storage 572 may include volatile and nonvolatile memories, removable and non-removable media implemented in any method or technology for storage of information, such as computer readable instructions, data structures, program modules, or other data. Examples of storage media of storage 572 can include random access memory, read only memory, magnetic disks, optical disks, CDs, DVDs, flash memory, magnetic cassettes, magnetic tape, magnetic disk storage or other magnetic storage devices, or any other suitable storage media. In no case is the storage medium a transitory propagated signal.

Storage 572 may be implemented as a single storage device but may also be implemented across multiple storage devices or sub-systems co-located or distributed relative to each other. Storage 572 may include additional elements, such as a controller, capable of communicating with processor 570.

The I/O interface 574 can include devices and components that enable communication between a user and the NFC-enabled device 550. The I/O interface 574 can include input devices such as a mouse, track pad, keyboard, a touch device for receiving a touch gesture from a user, a motion input device for detecting non-touch gestures and other motions by a user, a microphone for detecting speech, and other types of input devices and their associated processing elements capable of receiving user input. The I/O interface 574 can also include output devices such as display screen(s), speakers, haptic devices for tactile feedback, and other types of output devices. In certain cases, the input and output devices may be combined in a single device, such as a touchscreen, or touch-sensitive, display which both depicts images and receives touch gesture input from the user. A touchscreen (which may be associated with or form part of the display) is an input device configured to detect the presence and location of a touch. The touchscreen may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen is incorporated on top of a display as a transparent layer to enable a user to use one or more touches to interact with objects or other information presented on the display.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method, comprising:
capturing, via an NFC-enabled device, a QR code enabling a physical payment card payment for an online transaction at an online merchant, wherein the QR code comprises a soft-point-of-sale (soft-POS) instance identifier with details comprising transaction details of the online transaction;
decoding the QR code; and
executing the soft-POS instance by:
directing a browser to open on the NFC-enabled device;
sending, via the browser, a soft-POS instance launch request comprising the soft-POS identifier;
receiving, via the browser, an interface for the soft-POS instance and a payment pin;
in response to receiving the payment pin, activating a near field communication (NFC) element of the NFC-enabled device;
receiving, via the NFC element of the NFC-enabled device, a card-present (CP) payment credential from a physical payment card; and
sending, by the soft-POS instance, the CP payment credential and the transaction details associated with the online transaction to a payment network.

2. The method of claim 1, wherein the details encoded by the QR code further comprise a mixed CNP/CP flag indicating that a transaction type of the online transaction is a CNP-to-CP transaction type.

3. The method of claim 1, further comprising:
during the executing of the soft-POS instance, obtaining an NFC-enabled device identifier associated with the NFC-enabled device.

4. The method of claim 1, wherein capturing, via the NFC-enabled device, the QR code comprises capturing, via a camera of the NFC-enabled device, the QR code displayed at a graphical user interface (GUI) of a user device, wherein the online transaction was initiated at the user device.

5. The method of claim 1, wherein the soft-POS instance is time-limited.

6. The method of claim 1, further comprising:
receiving, by the soft-POS instance, confirmation of approval of the online transaction; and
in response to receiving, by the soft-POS instance, confirmation of the approval of the online transaction, closing the soft-POS instance at the NFC-enabled device.

7. The method of claim 1, further comprising:
displaying, at the interface for the soft-POS instance at the NFC-enabled device, a personal identification number (PIN) entry request;
receiving, at the NFC-enabled device, a PIN entered at the interface of the soft-POS instance; and
sending, by the soft-POS instance, the entered PIN to a soft-POS service.

8. A method, comprising:
receiving, at a soft-point-of-sale (soft-POS) service, a soft-POS instance launch request from an NFC-enabled device for an online transaction at an online merchant;
sending a soft-POS instance and a payment pin to a browser of the NFC-enabled device to execute the soft-POS instance via the browser of an NFC-enabled device and activate a near field communication (NFC) element of the NFC-enabled device, wherein the soft-POS instance comprises transaction details of the online transaction; and
receiving, at the soft-POS service, a card-present (CP) payment credential from a physical payment card from the NFC-enabled device.

9. The method of claim 8, further comprising:
sending, via a payment network, an authorization request for the online transaction to an issuer, wherein the authorization request comprises the CP payment credential; and
receiving, at the soft-POS service via the payment network, authorization approval from the issuer.

10. The method of claim 8, further comprising:
receiving, at the soft-POS service, a card-not-present to card-present (CNP-to-CP) transaction type conversion request associated with the online transaction, wherein the CNP-to-CP transaction type conversion request requests to convert a transaction type for the online transaction from a CNP transaction to a CP transaction, and wherein the CNP-to-CP transaction type conversion request comprises the transaction details associated with the online transaction at the online merchant;
in response to receiving the CNP-to-CP transaction type conversion request, generating, at the soft-POS service, the soft-POS instance associated with the online transaction;
generating a QR code including a soft-POS instance identifier for the soft-POS instance associated with the online transaction; and
sending the QR code including the soft-POS instance identifier a user device, wherein the online transaction was initiated at the user device.

11. The method of claim 10, further comprising:
in response to receiving, at the soft-POS service, the CNP-to-CP transaction type conversion request, generating a mixed CNP/CP flag indicating that a transaction type of the online transaction is a CNP-to-CP transaction type;
wherein generating, at the soft-POS service, the QR code comprises including the mixed CNP/CP flag in the QR code.

12. The method of claim 11, wherein the transaction details comprise a user device identifier associated with the user device.

13. The method of claim 12, wherein receiving, at the soft-POS service, the CP payment credential from the physical payment card from the NFC-enabled device comprises receiving an NFC-enabled device identifier associated with the NFC-enabled device, further comprising:
storing, at a storage resource, the CP payment credential, the mixed CNP/CP flag, the user device identifier, and the NFC-enabled device identifier.

14. A system comprising:
a processing system;
one or more storage media; and
instructions stored on the one or more storage media that, when executed by the processing system, direct the processing system to at least:
receive, at a soft-POS service, a card-not-present to card-present (CNP-to-CP) transaction type conversion request associated with an online transaction, wherein the CNP-to-CP transaction type conversion request requests to convert a transaction type for the online transaction from a CNP transaction to a CP transaction, and wherein the CNP-to-CP transaction type conversion request comprises transaction details associated with the online transaction at an online merchant;
in response to receiving the CNP-to-CP transaction type conversion request, generate, at the soft-POS service, a soft-POS instance associated with the online transaction;
generate a QR code including a soft-POS instance identifier for the soft-POS instance associated with the online transaction;
send the QR code including the soft-POS instance identifier to a user device, wherein the online transaction was initiated at the user device;
receive, at a soft-point-of-sale (soft-POS) service, a soft-POS instance launch request from an NFC-enabled device for an online transaction at an online merchant;
send a soft-POS instance and a payment pin to a browser of the NFC-enabled device to execute the soft-POS instance via the browser of the NFC-enabled device and activate a near field communication (NFC) element of the NFC-enabled device, wherein the soft-POS instance comprises transaction details of the online transaction; and
receive, at the soft-POS service, a card-present (CP) payment credential from a physical payment card from the NFC-enabled device.

15. The system of claim 14, wherein the instructions further direct the processing system to:
send, via a payment network, an authorization request for the online transaction to an issuer, wherein the authorization request comprises the CP payment credential; and
receive, at the soft-POS service via the payment network, authorization approval from the issuer.

16. The system of claim 14, wherein the instructions to receive, at the soft-POS service, the CNP-to-CP transaction type conversation request further directs the processing system to:
generate a mixed CNP/CP flag indicating that a transaction type of the online transaction is a CNP-to-CP transaction type;
wherein the QR code comprises the mixed CNP/CP flag.

17. The system of claim 16, wherein the transaction details comprise a user device identifier associated with the user device.

18. The system of claim 17, wherein the instructions to receive, at the soft-POS service, the CP payment credential from the physical payment card from the NFC-enabled device further direct the processing system to receive a NFC-enabled device identifier associated with the NFC-enabled device, wherein the instructions further direct the processing system to:
store, at a storage resource, the CP payment credential, the user device identifier, and the NFC-enabled device identifier.
